(19) United States
(12) Patent Application Publication
(10) Pub. No.: US 2014/0250444 A1
(43) Pub. Date: Sep. 4, 2014

(54) INFORMATION PROCESSING SYSTEM, DEVICE AND INFORMATION PROCESSING METHOD

(71) Applicant: Zentaroh ONO, Tokyo (JP)

(72) Inventor: Zentaroh ONO, Tokyo (JP)

(73) Assignee: RICOH COMPANY, LTD., Tokyo (JP)

(21) Appl. No.: 14/192,932

(22) Filed: Feb. 28, 2014

(30) Foreign Application Priority Data
Mar. 4, 2013 (JP) 2013-041704
Sep. 26, 2013 (JP) 2013-199766

(51) Int. Cl. G06F 9/44; G06F 9/54

(52) U.S. Cl. CPC G06F 9/4443; G06F 9/541
USPC 719/328

(57) ABSTRACT

An information processing system includes a device including a first interface unit configured to execute a first process according to a use request of a function of the device upon receiving the use request from a program through a first interface, a computer configured to provide display data for the device, and a second interface unit provided in the device and configured to execute a second process according to the use request of the function of the device upon receiving the use request from the display data through a second interface. The second interface unit inputs a call request of the first interface corresponding to the use request into the first interface unit upon receiving the use request through the second interface.

### BACKGROUND OF THE INVENTION

1. Field of the Invention

The present invention relates to an information processing system, a device and an information processing method.

2. Description of the Related Art

Conventionally, for example, there is an image forming apparatus that includes a published API (Application Program Interface), an application developed by using the API (which is hereinafter called a “SDK (Software Development Kit) application”) and an application platform (which is hereinafter called “SDK Platform”) that provides an execution environment, in image forming apparatuses called multifunction machines or fusion machines, as disclosed in Japanese Laid-Open Patent Application Publication No. 2005-269619.

Moreover, in the image forming apparatuses provided with the SDK platform, an image forming apparatus loading browser software that displays HTML (Hyper Text Markup Language) data as an operation screen exists. Some of the browser software can implement device control by interpreting a script extended for device control (which is hereinafter called an “extension script”) as well as displaying a screen. A method of “doScan” is taken as an example of the extension script. The “doScan” is an extension script indicating an executive instruction of scanning. According to browser software capable of interpreting the extension script, the extension script can be offered for customization of the API of a browser base, as disclosed in Japanese Laid-Open Patent Application Publication No. 2006-352845.

A developer of the application for the above image forming apparatus can develop an application by selecting either a mode such as the SDK application utilizing the API that the SDK platform provides (which is hereinafter called a “SDAPI”) or a mode such as a Web page utilizing the extension script, in accordance with a property or the like of the application.

However, because the SDK platform and the browser software are different programs from each other, a difference may be caused in response situations in response to a function of the image forming apparatus. For example, a situation can be caused in which the extension script is not provided although the SDKAPI to utilize a certain function is provided. In such a case, a situation can be caused in which a function cannot be implemented by the Web page although the function can be implemented by the SDK application.

Here, the above problems are thought to be common issues in a mode in which an application developed by using the published API makes a device execute a process, regardless of the providing mode of the SDK.

### SUMMARY OF THE INVENTION

Accordingly, embodiments of the present invention may provide a novel and useful information processing system, device and information processing method solving or reducing one or more of the above-described problems.

More specifically, the embodiments of the present invention may provide an information processing system, a device and an information processing method that can reduce an occurrence of a function difference between a plurality of interfaces having different modes to allow a function of a device to be utilized.

According to one embodiment of the present invention, there is provided an information processing system that includes a device including a first interface unit configured to execute a first process according to a use request of a function of the device upon receiving the use request from a program through a first interface, a computer configured to provide display data for the device, and a second interface unit provided in the device and configured to execute a second process according to the use request of the function of the device upon receiving the use request from the display data through a second interface. The second interface unit inputs a call request of the first interface corresponding to the use request into the first interface unit upon receiving the use request through the second interface.

According to another embodiment of the present invention, there is provided a device that includes a first interface unit configured to execute a first process according to a use request of a function of the device upon receiving the use request from a program through a first interface, and a second interface unit configured to execute a second process according to the use request of the function of the device upon receiving the use request from display data through a second interface. The second interface inputs a call request of the first interface corresponding to the use request into the first interface unit upon receiving the use request through the second interface.

According to another embodiment of the present invention, there is provided an information processing method. In the method, a computer provides display data for a device. In the meanwhile, a first interface unit in the device executes a first process according a use request of a function of the device upon receiving the use request from a program through a first interface, and a second interface unit in the device executes a second process according to the use request of the function of the device upon receiving the use request from the display data provided by the computer through a second interface. The second interface unit inputs a call request of the first interface corresponding to the use request into the first interface unit in the second process.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating an example of a system configuration according to an embodiment of the present invention;

FIG. 2 is a diagram illustrating an example of a hardware configuration of an image forming apparatus according to an embodiment of the present invention;

FIG. 3 is a diagram illustrating an example of a hardware configuration of a Web server apparatus according to an embodiment of the present invention;

FIG. 4 is a diagram illustrating an example of a functional configuration of each apparatus according to an embodiment of the present invention;

FIG. 5 is a sequence diagram for explaining an example of a processing procedure executed by an image forming apparatus and a Web server apparatus; and

FIG. 6 is a diagram illustrating an example of a configuration of a determination table.

### DETAILED DESCRIPTION OF THE PREFERRED EMBODIMENTS

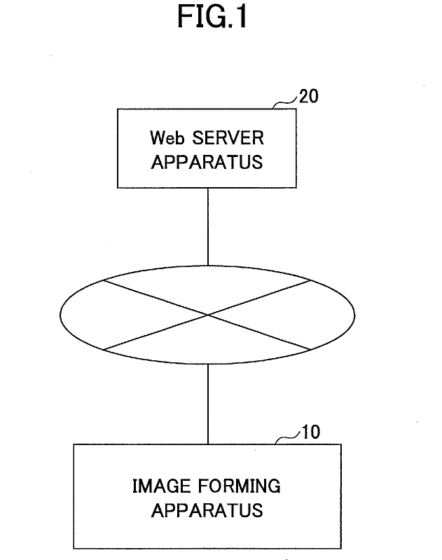

A description is given, with reference to the accompanying drawings, of respective embodiments of the present invention. FIG. 1 is a diagram illustrating an example of a system configuration according to an embodiment of the present invention. In FIG. 1, an image forming apparatus 10 and a Web server apparatus 20 are configured to be communicable through a network such as a LAN (Local Area Network) or the Internet.

The image forming apparatus 10 is a multifunction machine that implements two or more functions among printing, scanning, copying, FAX sending and receiving and the like by a single unit. However, a device having any one of the functions may be used as the image forming apparatus 10. In the present embodiment, the image forming apparatus 10 includes a Web browser as a program that forces an operation panel (i.e., operation panel 15 described later) to implement displaying a Web page or the like. A function of the Web browser is extended to be suitable for the image forming apparatus 10. For example, the Web browser can interpret a script (which is hereinafter called an “extension script”) to control hardware (to receive an execution instruction such as scanning or printing) inherent in the image forming apparatus 10. Hereinafter, the Web browser owned by the image forming apparatus 10 is called a “device browser.”

The Web server apparatus 20 includes a Web application that provides services through a Web page. In the present embodiment, the Web page means data that define or describe a script and the like showing screen information defined based on a predetermined format or process instructions executed depending on operation and the like to a screen displayed based on the screen information. In the present embodiment, the screen based on the Web page provided by the Web server apparatus 20 is displayed on the operation panel.

Here, two or more image forming apparatuses 10 may receive the provision of the Web page from a single Web server apparatus 20. Moreover, a single image forming apparatus 10 may receive the provision of the Web page from a plurality of Web server apparatuses 20. Furthermore, the Web server apparatus 20 may be a single computer or a computer system including a plurality of computers.

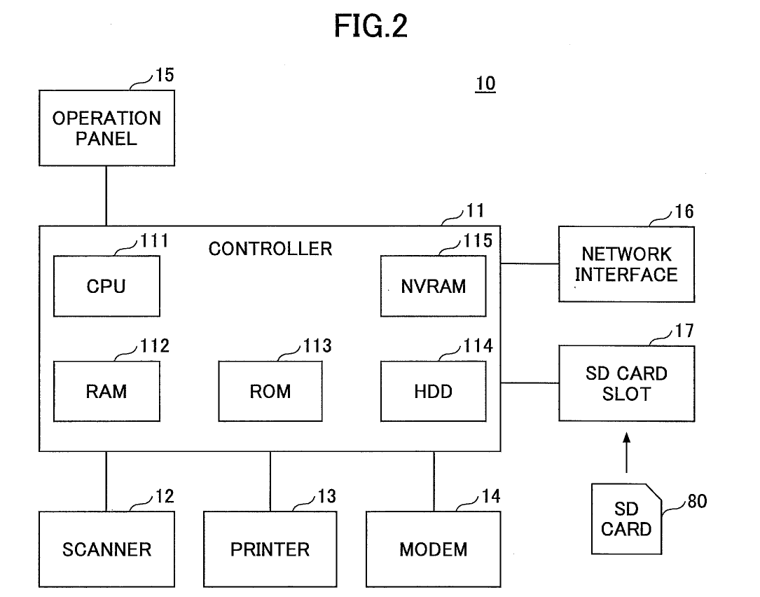

FIG. 2 is a diagram illustrating an example of a hardware configuration of the image forming apparatus according to an embodiment of the present invention. In FIG. 2, the image forming apparatus 10 includes hardware such as a controller 11, a scanner 12, a printer 13, a modem 14, an operation panel 15, a network interface 16, and an SD card slot 17.

The controller 11 includes a CPU 111, a RAM 112, a ROM 113, an HDD 114, an NVRAM 115 and the like. The ROM 113 stores various programs, or data and the like utilized by the programs. The RAM 112 is used as a memory area to load a program or a working area of the loaded program. The CPU 111 implements various functions by processing the program loaded in the RAM 112. The HDD 114 stores a program or various data and the like utilized by the program. The NVRAM 115 stores a variety of setting information and the like.

The scanner 12 is hardware to read image data from a manuscript (i.e., image reading unit). The printer 13 is hardware to print printing data on a sheet of printing paper (i.e., printing unit). The modem 14 is hardware to connect the image forming apparatus 10 to a telephone line, and is used to send and receive image data by FAX communication. The operation panel 15 is hardware that includes an input unit such as a button to receive input from a user, a display unit such as a liquid crystal panel, or the like. The liquid crystal panel may have a touch panel function. In this case, the liquid crystal panel also has a function of the input unit. The network interface 16 is hardware to connect the image forming apparatus 10 to a network such as a LAN (either by a wired network or a wireless network). The SD card slot 17 is utilized to read a program stored in an SD card 80. More specifically, the image forming apparatus 10 can run not only a program stored in the ROM 113 but also the program stored in the SD card 80 by loading the program into the RAM 112. Here, the SD card 80 may be replaced by another recording medium (e.g., a CD-ROM, a USB (Universal Serial Bus) memory or the like). In other words, a kind of the recording medium corresponding to a position of the SD card 80 is not limited to a predetermined medium. In this case, the SD card slot 17 may be replaced by hardware depending on a kind of the recording medium.

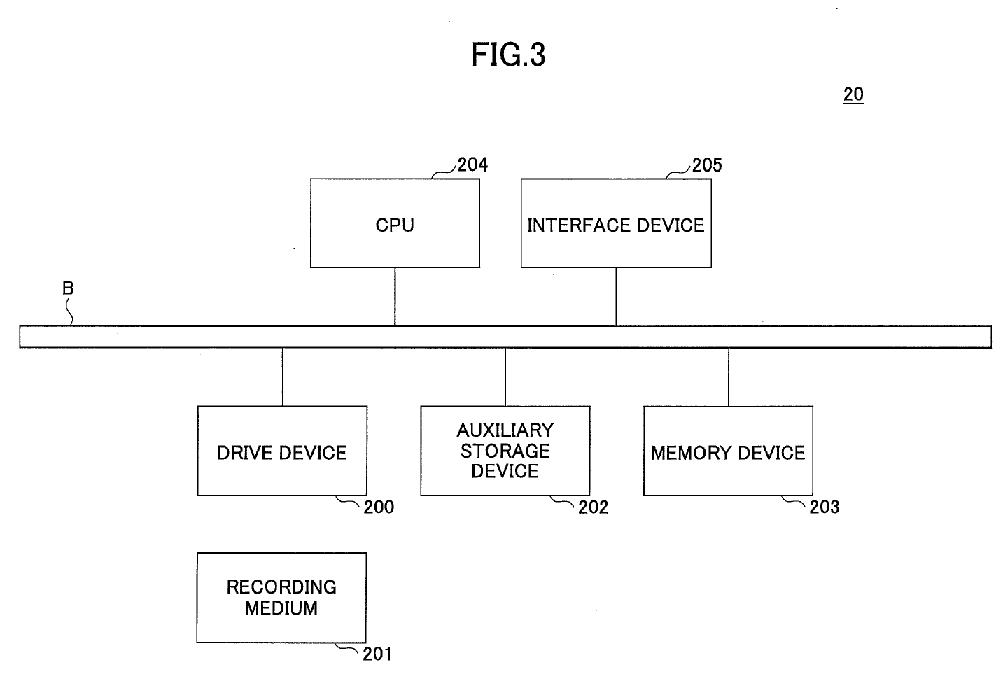

FIG. 3 is a diagram illustrating an example of a hardware configuration of the Web server apparatus 20 according to an embodiment of the present invention. The Web server apparatus 20 in FIG. 3 includes a drive device 200, an auxiliary storage device 202, a memory device 203, a CPU 204, an interface device 205 and the like.

A program to make the Web server apparatus 20 execute a process is provided by the recording medium 201 such as a CD-ROM. When the recording medium 201 that stores the program is set in the drive device 200, the program is installed into the auxiliary storage device 202 from the recording medium 201 through the drive device 200. However, the program does not necessarily have to be installed from the recording medium 201, and the program may be downloaded from another computer through the network. The auxiliary storage device 202 stores a necessary file, data and the like as well as the installed program.

The memory device 203 reads the program from the auxiliary storage device 202 and stores therein when receiving a start instruction of the program. The CPU 204 executes a function involving the Web server apparatus 20 according to the program stored in the memory device 203. The interface device 205 is used as an interface to connect the Web server apparatus 20 to the network.

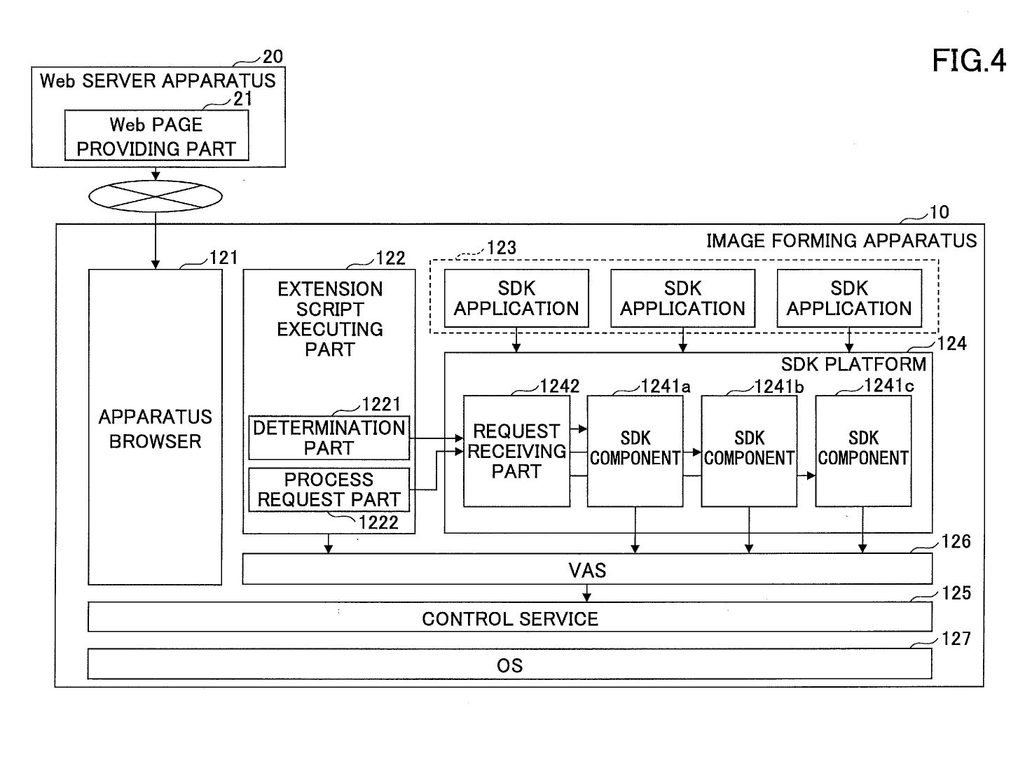

FIG. 4 is a diagram illustrating a functional configuration of each apparatus according to an embodiment of the present invention. In FIG. 4, the image forming apparatus 10 includes a device browser 121, an extension script executing part 122, at least one SDK application 123, an SDK platform 124, a control service 125, a VAS 126, an OS 127 and the like. These are programs that implement each of the functions thereof by making the CPU 111 execute a process.

The device browser 121 is the above-mentioned device browser. The extension script executing part 122 controls a process depending on an extension script. The extension script is an example of an interface to receive a use request or an execution request of a function of the image forming apparatus 10 from the Web page. The device browser 121, when detecting an extension script in the Web page, requests the extension script executing part 122 to execute the extension script. The extension script executing part 122 inputs a process request corresponding to the extension script into the control service 125 through the VAS 126.

The SDK application 123 is an application program or a plug-in additionally installed into the image forming apparatus 10 to perform the extension of a function or the like after the image forming apparatus 10 is delivered.

The SDK platform 124 includes an API (Application Program Interface) to develop the SDK application, and provides an execution environment of the SDK application 123. A mode of the API may be, for example, a function, or a class of an object-orientation and a method of a class and the like. The API provided by the SDK platform 124 is hereinafter called a “SDKAPI.” The SDKAPI is an example of an interface to receive a use request or an execution request of a function of the image forming apparatus 10 from the SDK application 123.

In FIG. 4, SDK components 1241 contained in the SDK platform 124 are software components that provide the SDKAPI. Each of the SDK components 1241 provides the SDKAPI classified for each SDK component based on a commonality of each of the functions. For example, an SDK component 1241a provides an SDKAPI relating to a scanning function for the SDK application 123; an SDK component 1241b provides an SDKAPI relating to a print function for the SDK application 123; and an SDK component 1241c provides an SDKAPI and the like relating to a FAX function for the SDK application 123. Each of the SDK components 1241 inputs a process request corresponding to the called SDKAPI into the control service 125 through the VAS 126. Here, the SDKAPI is published, and the SDK application 123 can be developed by a third vendor. Moreover, the SDK platform 124 may contain Java™ VM (Virtual Machine). In this case, the SDK application 123 is implemented by Java™ language.

The control service 125 is a program module group that provides an interface (API) to control various hardware resources and the like for a program at an upper level layer or executes a base function and the like of the image forming apparatus 10.

The VAS (Virtual Application Service) 126 wraps the interface of the control service 125 (incorporates the interface of the control service 125 and provides it in another form), and absorbs a difference in interface caused by upgrading a version of the control service 125.

Accordingly, with respect to the program that runs on the VAS 126, compatibility of the control service 125 between each of the versions is ensured.

The OS 127 is a so-called OS (Operating System). Each software on the image forming apparatus 10 operates as a process or a thread on the OS 127.

In the meantime, in FIG. 4, the extension script executing part 122 includes a determination part 1221 and a process request part 1222. The determination part 1221 determines whether either the extension script executing part 122 or the SDK platform 124 is responsible for executing a process according to an execution request of the extension script from the device browser 121 (which is hereinafter called an “execution responsibility”). When the determination part 1221 determines that the SDK platform 124 has the execution responsibility, the process request part 1222 inputs the process request according to the extension script of an execution object into the SDK platform 124.

The SDK platform 124 includes a request receiving part 1242. The request receiving part 1242 provides an interface to receive a process request from the process request part 1222 of the extension script executing part 122. The interface may be, for example, implemented by using interprocess communication. The request receiving part 1242 makes any of the SDK components 1241a through 1241c execute a process according to the received process request.

Thus, cooperation between the extension script executing part 122 and the SDK platform 124 can be implemented by the process request of the extension script executing part 122 and the request receiving part 1242 of the SDK platform 124. As a result, a process according to the extension script that is described on the Web page can be transferred to the SDK platform 124.

On the other hand, the Web server apparatus 20 includes a Web page providing part 21 and the like. The Web page providing part 21 provides a Web page according to the request that the device browser 121 makes the image forming apparatus 10 send (HTTP request). The Web page providing part 21 implements the program installed in the Web server apparatus 20 by making the CPU 204 execute the process according to the program.

The Web page may be dynamically generated in response to a request, or may be preliminarily stored in the Web server apparatus 20 or a memory device and the like connected to the Web server apparatus 20 through the network. Here, the image forming apparatus 10 may include the Web page providing part 21. In other words, the Web page may be obtained from the inside of the image forming apparatus 10.

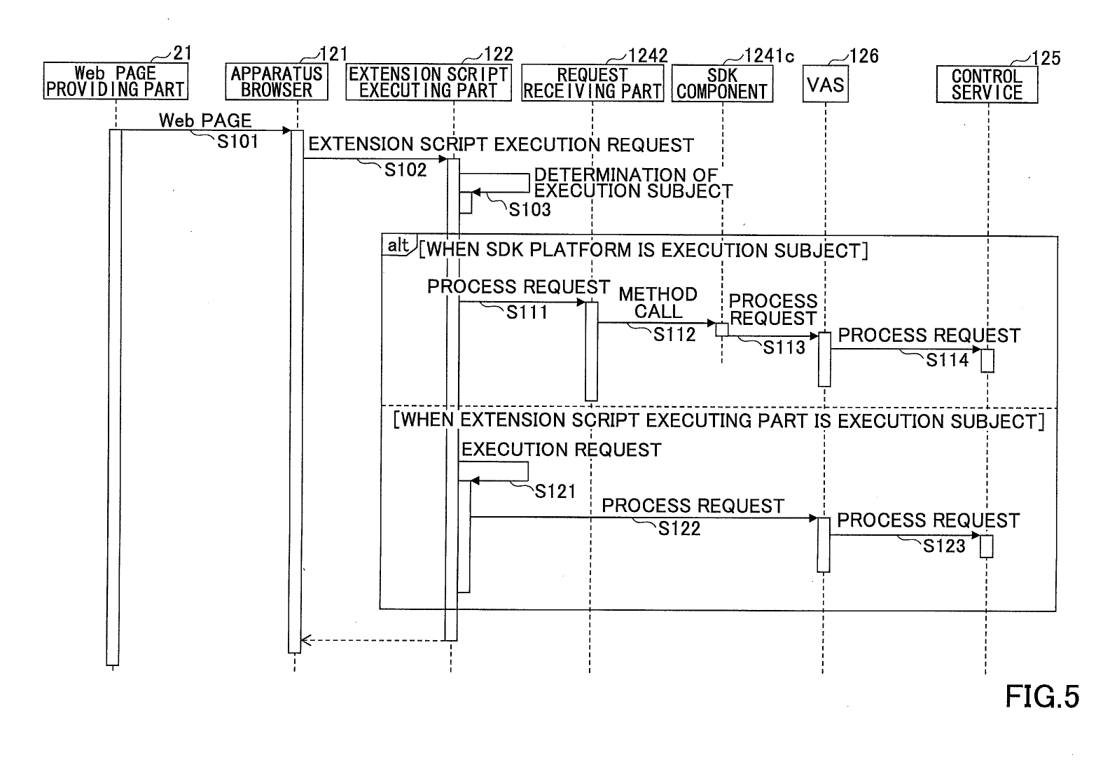

A description is given below of a processing procedure executed by the image forming apparatus 10 and the Web server apparatus 20. FIG. 5 is a sequence diagram for explaining an example of the processing procedure executed by the image forming apparatus 10 and the Web server apparatus 20.

In step S101, the Web page providing part 21 sends a response including a Web page according to a request from the device browser 121 to the device browser 121. The request from the device browser 121 is, for example, sent to the Web server apparatus 20 depending on operation by a user to the operation panel 15. The device browser 121 analyzes the Web page, and requests the extension script executing part 122 to execute an extension script when detecting the extension script (S102). Here, the device browser 121 executes a standard script (e.g., standard Java™ script). Furthermore, step S102 may be performed automatically in the course of displaying a screen on the operation panel 15 based on the screen information contained in the Web page, or may be performed after displaying the screen. When step S102 is performed after displaying the screen, step S102 may be performed according to the operation by the user to any operation parts on the screen. The timing when step S102 is performed depends on a definition of the Web page.

The determination part 1221 of the extension script executing part 122 determines an execution subject of a process according to the extension script of the execution request (S103). The execution subject is a subject responsible for execution. The determination of the execution subject is performed, for example, based on a determination table stored in the HDD 114.

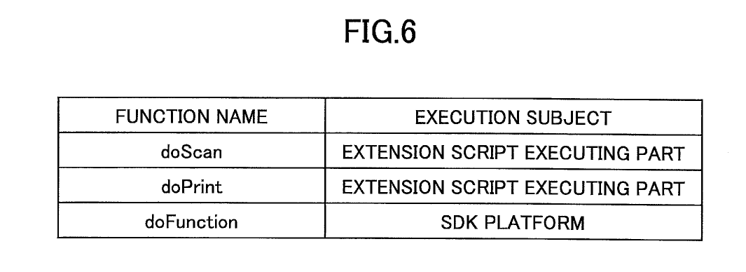

FIG. 6 is a diagram illustrating an example of a configuration of the determination table. In FIG. 6, the determination table stores identification information of the execution subject for each function name of the extension script. In FIG. 6, doScan, doPrint, and doFunction are illustrated as functions of the extension script.

The doScan is a function of the extension script showing an execution request of scanning (i.e., use request of a scanning function) to the image forming apparatus 10. The doPrint is a function of the extension script showing an execution request of printing (i.e., use request of a print function) to the image forming apparatus 10. According to FIG. 6, an execution subject of the doScan and the doPrint is made the extension script executing part 122. This is because implementation of the doScan and the doPrint is contained in the extension script executing part 122.

In contrast, the doFunction is a function that is not specified by only a function name, and has, for example, the following interface specification.

doFunction (<service name>, <method name>, argument 1, argument 2, . . . , argument N, <callback function>)

In the <service name> that is a first argument, identification information of the SDK component 1241 is specified. For example, a name is provided for each SDK component 1241, and the name is specified as the first argument. In the <method name> that is a second argument, a character string showing a method name of a method that the SDK component 1241 provides is specified. An argument relating to a method of the method name is specified as the third argument or later. Accordingly, the number of the argument of the third argument or later can differ depending on the method name specified as the second argument.

The <callback function> of the last argument is identification information of the callback function to receive a response when the response of the method specified by the <service name> and the <method name> is not performed in synchronization with the call of the method but performed asynchronously with the call. The identification information of the callback function is, for example, address information or a function name of the callback function.

In this manner, “doFunction” is a function of the extension script capable of calling a plurality of methods provided by the SDK component 1241 from the Web page. In FIG. 6, the execution subject of the doFunction is made the SDK platform 124.

Next, the process branches off depending on a determination result by the determination part 1221. More specifically, when the determination part 1221 determines that the execution subject is the SDK platform, that is to say, that the extension script of the execution object is the doFunction, steps S111 through S114 are performed.

In step S111, the process request part 1222 of the extension script executing part 122 inputs a process request including a value of the argument specified by the doFunction into the request receiving part 1242 of the SDK platform 124. In the present embodiment, for example, the following values are assumed to be specified as each of the arguments.

doFunction (“FAX”, “send”, <address>, <transmission file ID>, “callbackFunc”)

Accordingly, a process request including the “FAX”, “send”, <address>, <transmission file ID>, “callbackFunc” is input into the request receiving part 1242. The process request corresponds to a calling request of a method specified by the argument.

Subsequently, the request receiving part 1242 retrieves the SDK component 1241c corresponding to the “FAX” of the first argument from the SDK component 1241, and calls the following methods included in the SDK component 1241c, for example, by the following format (S112).

send (<address>, <transmission file ID>, “callbackFunc”)

More specifically, the request receiving part 1242 interprets the character string specified as the second argument of the doFunction as a method name to call, and the third or later character string as an argument corresponding to a method involved in the method name. Accordingly, the value of the second argument or later is specified as an argument of the send method without any change.

In this way, the request receiving part 1242 mechanically creates a calling format of the method for the SDK component 1241 based on a position of each argument of the doFunction. In other words, the request receiving part 1242 does not change the processing content depending on the argument value of the doFunction. Hence, for example, when a new SDK component 1241 is added, the request receiving part 1242 can mechanically or dynamically call the method of the new SDK component 1241 as well as the method of the existing SDK component 1241.

Here, the send method may be a method constituting the SDKAPI. In other words, the method that the request receiving part 1242 calls may be the SDKAPI. By doing this, the necessity of newly implementing a method for being called from the request receiving part 1242 in the respective component 1241 can be reduced.

The SDK component 1241c from which the send method is called inputs a process request according to the send method into the control service 125 through the VAS 126 (S113, S114). As a result, for example, transmission of FAX is performed. Here, when a resolvable method is called in the SDK component 1241c, an input of the process request into the control service 125 through the VAS 126 may not be executed. The resolvable method in the SDK component 1241c means, for example, a method that executes a process that does not need control or the like of the hardware resources in the image forming apparatus 10.

In contrast, in step S103, when the determination part 1221 determines that the execution subject is the extension script executing part 122, that is to say, when the extension script of the execution object is the doScan or the doPrint, steps S121 through S123 are performed.

In step S121, the extension script executing part 122 inputs an execution request into the component corresponding to the function of the execution object (component in the extension script executing part 122). When the function executes a process that needs the control or the like of the hardware resources of the image forming apparatus 10, the component inputs the process request according to the function into the control service 125 through the VAS 126 (S122, S123). As a result, for example, scanning is performed when the function is the doScan, and printing is performed when the function is the doPrint.

Here, the function of the script may be just called without performing the determination by the determination part 122. In this case, whether any one of the extension script executing part 122 and the SDK platform 124 is the execution subject just has to be clearly implemented in the script function. By doing this, the divergence between steps S111 through S114 and steps S121 through S123 can be achieved.

As discussed above, in the present embodiment, “doFunction” that is mutually available for a plurality of methods in the SDK component 241 can be described on the Web page as the extension script. More specifically, “doFunction” is mutually available not only for the send method, but also for the other multiple methods owned by the SDK component 1241 (e.g., a scan method, a print method and the like) in the present embodiment. Accordingly, the necessity of defining the extension script can be reduced for each method that the SDK component publishes. As a result, the necessity of altering the device browser 121 to make the function of the image forming apparatus 10, which is originally available through the SDKAPI in the SDK platform 124, available from the Web page, can be reduced. In other words, occurrence of the functional difference between the interfaces having different modes such as the difference between the SDKAPI and the extension script can be reduced.

Here, the doScan and the doPrint may be implemented so as to call the doFunction internally. By doing this, the implementation of the process according to the call of the script can be unified on the SDK platform 124 side while ensuring facility of description of the script. The reason why the facility of description of the script can be ensured is because a function having a specified function to execute such as the doScan and the doPrint is easier in specifying the argument than the doFunction.

Here, display data that have a different format from the Web page and can describe a command such as a script in the Web page may be used instead of the Web page.

Moreover, the present embodiments may be applied not only to the image forming apparatus but also to a device other than the image forming apparatus such as a projector, a device for a TV conference, a digital camera or other devices and apparatuses.

Here, in the present embodiments, the SDKAPI is an example of a first interface. The SDK platform 124 or the SDK component 1241 is an example of the first interface unit. The extension script is an example of a second interface. The device browser 121 and the extension script executing part 122 are an example of a second interface unit.

The present application is based on and claims the benefit of priority of Japanese Priority Patent Application No. 2013-41704, filed on Mar. 4, 2013, and Japanese Priority Patent Application No. 2013-199766, filed on Sep. 26, 2013, the entire contents of which are incorporated herein by reference.

What is claimed is:

1. An information processing system, comprising:
a device including a first interface unit configured to execute a first process according to a use request of a function of the device upon receiving the use request from a program through a first interface;
a computer configured to provide display data for the device; and
a second interface unit provided in the device and configured to execute a second process according to the use request of the function of the device upon receiving the use request from the display data through a second interface, the second interface unit inputting a call request of the first interface corresponding to the use request into the first interface unit upon receiving the use request through the second interface.

2. The information processing system of claim 1,
wherein the second interface specifies a name of the first interface as a value of an argument, and
the second interface unit inputs the call request of the first interface corresponding to the name specified as the argument of the second interface into the first interface unit.

3. The information processing system of claim 1, wherein the display data are data of a Web page, and the second interface is a script.

4. A device, comprising:
a first interface unit configured to execute a first process according to a use request of a function of the device upon receiving the use request from a program through a first interface; and
a second interface unit configured to execute a second process according to the use request of the function of the device upon receiving the use request from display data through a second interface, the second interface unit inputting a call request of the first interface corresponding to the use request into the first interface unit upon receiving the use request through the second interface.

5. The device of claim 4,
wherein the second interface specifies a name of the first interface as a value of an argument, and
the second interface unit inputs the call request of the first interface corresponding to the name specified as the argument of the second interface into the first interface unit.

6. The device of claim 4, wherein the display data are data of a Web page, and the second interface is a script.

7. An information processing method, comprising steps of:
providing display data for a device by a computer;
executing a first process according a use request of a function of the device upon receiving the use request from a program through a first interface by a first interface unit in the device; and
executing a second process according to the use request of the function of the device upon receiving the use request from the display data provided by the computer through a second interface by a second interface unit in the device, a call request of the first interface corresponding to the use request being inputted into the first interface unit in the second process.

8. The information processing method of claim 7,
wherein the second interface specifies a name of the first interface as a value of an argument, and
the second interface unit inputs the call request of the first interface corresponding to the name specified as the argument of the second interface into the first interface unit.

9. The information processing method of claim 7, wherein the computer provides data of a Web page as the display data, and the second interface is a script.
